(19) United States
(12) Patent Application Publication
(10) Pub. No.: US 2025/0329888 A1
(43) Pub. Date: Oct. 23, 2025

(54) BATTERY MODULE AND BATTERY PACK INCLUDING THE SAME

(71) Applicant: LG Energy Solution, Ltd., Seoul (KR)

(72) Inventor: Jae Yong Uhm, Daejeon (KR)

(21) Appl. No.: 18/867,397

(22) PCT Filed: Aug. 10, 2023
(86) PCT No.: PCT/KR2023/011803

§ 371 Date: Nov. 19, 2024

(30) Foreign Application Priority Data
Dec. 5, 2022 (KR) 10-2022-0167843

(51) Int. Cl. H01M 50/507; H01M 50/178; H01M 50/211; H01M 50/533; H01M 50/536

(52) U.S. Cl. CPC H01M 50/507; H01M 50/178; H01M 50/211; H01M 50/533; H01M 50/536

(57) ABSTRACT

A battery module includes: a battery cell stack in which battery cells are stacked along a first direction; and at least one busbar located on one side or both sides of the battery cell stack. An electrode lead protrudes from the battery cell along a second direction perpendicular to the first direction. The busbar includes a first portion, and a second portion that extends from the first portion at a certain angle with respect to one surface of the first portion, and the electrode lead is joined to the second portion.

### REFERENCE TO RELATED APPLICATIONS

The present application is a National Phase entry pursuant to 35 U.S.C. § 371 of International Application No. PCT/KR2023/011803 filed on Aug. 10, 2023, and claims priority to and the benefit of Korean Patent Application No. 10-2022-0167843 filed on Dec. 5, 2022 in the Korean Intellectual Property Office, the disclosures of which are incorporated herein by reference in their entirety.

### TECHNICAL FIELD

The present disclosure relates to a battery module and a battery pack including the same, and more particularly, to a battery module having a novel connection configuration of electrode leads and busbars, and a battery pack including the same.

### BACKGROUND ART

In modern society, as portable devices such as mobile phones, notebook computers, camcorders and a digital cameras have been used daily, the development of technologies in fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of secondary batteries is growing.

Generally, lithium secondary batteries may be classified into can-type secondary batteries in which the electrode assembly is mounted in a metal can, and pouch-type secondary batteries in which the electrode assembly is mounted in a pouch of an aluminum laminate sheet, depending on the shape of the exterior material.

In the case of a secondary battery used for small-sized devices, two to three battery cells are used, but in the case of a secondary battery used for a medium- and large-sized device such as automobiles, a battery module in which a plurality of battery cells are electrically connected is used. In such a battery module, a plurality of battery cells are connected to each other in series or parallel to form a cell assembly, thereby improving capacity and output. Further, one or more battery modules can be mounted together with various control and protection systems such as a BDU(Battery Disconnect Unit), a BMS(Battery Management System), and a cooling system, to form a battery pack.

A conventional battery module may utilize a busbar and a busbar frame for providing electrical connection between multiple battery cells. The structure of the busbar and busbar frame used in a conventional battery module will be described below with reference to FIGS. 1 and 2.

FIG. 1 is a perspective view showing a conventional battery module. FIG. 2 is a partial view which enlarges and shows section “A” in FIG. 1. In particular, FIG. 1 shows the state in which the battery module is erected to show the appearance of the busbar frame and busbar.

Referring to FIGS. 1 and 2, a conventional battery module 10 includes a battery cell stack 12 in which a plurality of battery cells 11 are stacked, and busbar frames 30 disposed on both sides of the battery cell stack 12. Such a busbar frame 30 may be mounted with a busbar 40.

The busbar 40 is for providing electrical connection between the plurality of battery cells 11. The electrode lead 11L of the battery cell 11 passes through a slit formed in the busbar frame 30, and then can be bent and connected to the busbar 40. In some cases, the electrode lead 11L may also pass through a slit 40S formed in the busbar 40.

When connecting between the electrode lead 11L and the busbar 40, the method is not limited as long as electrical connection is available, and for example, they may be connected by welding junction. The battery cells 11 may be electrically connected in series or parallel via the busbar 40.

The connection configuration of the battery cells 11 as mentioned above may be broken by tensile force. This will be explained with reference to FIG. 3.

FIG. 3 is a cross-sectional view for explaining breakage of an electrode tab or breakage of a connecting portion between an electrode tab and an electrode lead in a conventional battery module.

Referring to FIG. 3, the battery cell 11 can be produced by housing the electrode assembly 11A inside a pouch-shaped cell case 11C and then sealing the outer peripheral portion of the cell case 11C to form a sealing portion 11S. The electrode assembly 11A may include electrodes and a separator disposed between the electrodes. Respective electrodes include electrode tabs 11t, wherein the electrode tabs 11t may be connected to the electrode lead 11L by a method such as welding.

The electrode lead 11L protrudes to the outside of the cell case 11C, passes through a slit 30S of the busbar frame 30 and a slit 40S of the busbar 40 as mentioned above, and then can be bent and connected to the busbar 40.

Welding is performed by bringing the electrode lead 11L into close contact with the surface of the busbar 40. Although FIG. 3 shows only the case where one electrode lead 11L protruding from one battery cell 11 is joined to the busbar 40, there is also a case where a plurality of electrode leads 11L protruding from multiple battery cells 11 are joined to one busbar 40. In order to bring the electrode leads 11L into close contact with the surface of the busbar 40, the electrode leads 11L are bent to form a bent portion 11LB. Further, in order to bring multiple electrode leads 11L into close contact with the surface of the busbar 40, the length of the electrode leads 11L must be set differently for each battery cell 11. Therefore, the conventional battery module 10 essentially requires a process of cutting the electrode lead 11L and a process of bending the electrode lead 11L.

Further, in the process of bending the electrode lead 11L, a tensile force TF is generated in the electrode lead 11L. Due to this tensile force TF, stress may be concentrated on the electrode tab 11t or the connecting portion between the electrode tab 11t and the electrode lead 11L. Ultimately, in the worst cases, there may be a problem that the electrode tab 11t itself is broken or the connecting portion between the electrode tab 11t and the electrode lead 11L is broken. Since this is an important issue that can be related to the risk of fire due to internal short circuits, there is a need to develop a technology that can prevent breakage of the electrode tab or breakage of the connecting portion between the electrode tab and the electrode lead.

### SUMMARY OF THE INVENTION

It is an object of the present disclosure to provide a battery module having a novel connection configuration of electrode leads and busbars so as to prevent breakage of the electrode tab itself or breakage of the connecting portion between the electrode tab and the electrode lead, and a battery pack including the same.

However, the technical problems to be solved by embodiments of the present disclosure are not limited to the above-mentioned problems, and can be variously expanded within the scope of the technical idea included in the present disclosure.

A battery module according to an embodiment of the present disclosure comprises: a battery cell stack in which battery cells are stacked along a first direction; and at least one busbar located on one side or both sides of the battery cell stack. An electrode lead protrudes from one of the battery cells along a second direction perpendicular to the first direction. The busbar comprises a first portion, and a second portion that extends from the first portion at a certain angle with respect to one surface of the first portion, and the electrode lead is joined to the second portion.

The battery cell may be a pouch-type battery cell, and in the battery cell stack, the battery cells may be stacked in an upright state so that side surfaces of the battery cells face each other.

The second portion may extend so that one surface of the second portion is perpendicular to one surface of the first portion.

One surface of the first portion may be parallel to the first direction, and one surface of the second portion is parallel to the second direction.

The electrode lead may be welded and joined to the second portion.

The busbar may be formed with an open portion, the electrode lead may be joined to the second portion while passing through the open portion.

The battery module may further comprise a busbar frame located between the battery cell stack and mounted with the busbar. The busbar frame may be formed with a slit, and the electrode lead passes through the slit and may be joined to the second portion of the busbar.

The electrode lead may be formed with a bead portion protruding in a direction different from the second direction.

The bead portion may protrude from a middle portion of the electrode lead in a direction parallel to the first direction.

The bead portion may be a portion formed by bending the electrode lead at least three times.

A joining portion, which is a portion where the electrode lead and the second portion are joined, may be provided at a portion where the bead portion is connected to the electrode lead.

The portion where the bead portion is connected to the electrode lead may be irradiated with a laser to form the joining portion.

The battery module may further comprise a module frame in which the battery cell stack is housed.

According to an embodiment of the present disclosure, there is provided a battery pack comprising the battery module.

According to embodiments of the present disclosure, the busbar is designed to include a first portion and a second portion, so that the electrode lead can be joined to the busbar without bending. Thereby, since a bending portion is not formed in the electrode lead, tensile force due to bending does not act on the electrode lead, and it is possible to prevent breakage of the electrode tab or breakage of the connecting portion between the electrode tab and the electrode lead.

Since a bending portion is not formed in the electrode lead, a process of bending the electrode lead is not necessary. Further, since respective battery cells can be located regularly from the joining portion between the electrode lead and the busbar, a process of cutting the electrode lead is also not necessary.

In addition, according to embodiments of the present disclosure, a bead portion protruding from the electrode lead can be formed. Even if a bending portion is not formed in the electrode lead, the bead portion allows stable junction between the electrode lead and the busbar.

Effects obtainable from the present disclosure may be not limited by the above mentioned effects. And, other effects not mentioned herein can be clearly understood from the description of the claims by those skilled in the art.

### BRIEF DESCRIPTION OF THE DRAWINGS

FIG. 1 is a perspective view showing a conventional battery module;

FIG. 2 is a partial view which enlarges and shows section “A” in FIG. 1;

FIG. 3 is a cross-sectional view for explaining breakage of an electrode tab or breakage of a connecting portion between an electrode tab and an electrode lead in a conventional battery module;

FIG. 4 is an exploded perspective view showing a battery module according to an embodiment of the present disclosure;

FIG. 5 is a plan view showing one of the battery cells included in the battery module of FIG. 4;

FIG. 6 is a partial perspective view showing the battery cell stack and busbar included in the battery module of FIG. 4;

FIG. 7 is a partial perspective view which enlarges and shows the joining portion between the electrode leads of the battery cells and the busbar in FIG. 6;

FIG. 8 is a cross-sectional view showing a cross-section taken along the cutting line B-B′ of FIG. 6;

FIG. 9 is a perspective view showing a busbar according to an embodiment of the present disclosure;

FIGS. 10 and 11 are perspective and plan views, respectively, showing electrode leads of a battery cell according to an embodiment of the present disclosure;

FIGS. 12 and 13 are perspective and plan views, respectively, showing the process of joining an electrode lead and a busbar according to an embodiment of the present disclosure;

FIG. 14 is a perspective view showing an electrode lead of a battery cell according to another embodiment of the present disclosure; and

FIG. 15 is a perspective view showing a busbar frame according to an embodiment of the present disclosure.

### DETAILED DESCRIPTION

Hereinafter, various embodiments of the present disclosure will be described in detail with reference to the accompanying drawings so that those skilled in the art can easily carry them out. The present disclosure may be modified in various different ways, and is not limited to the embodiments set forth herein.

Portions that are irrelevant to the description will be omitted to clearly describe the present disclosure, and same reference numerals designate same or like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

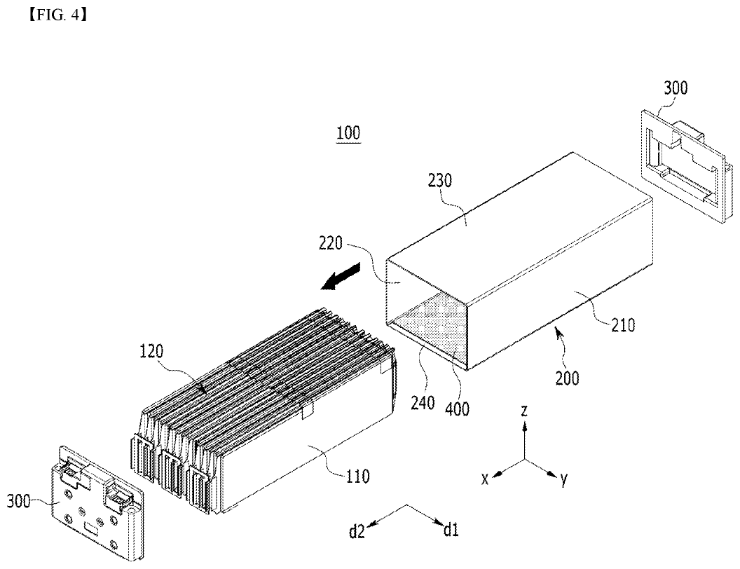

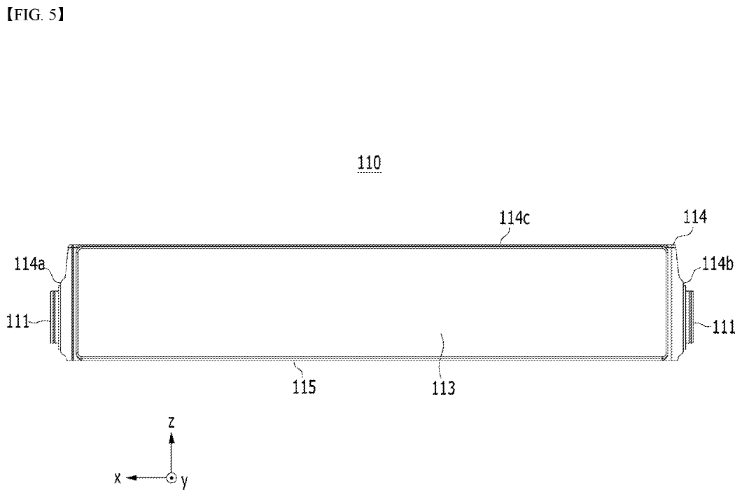

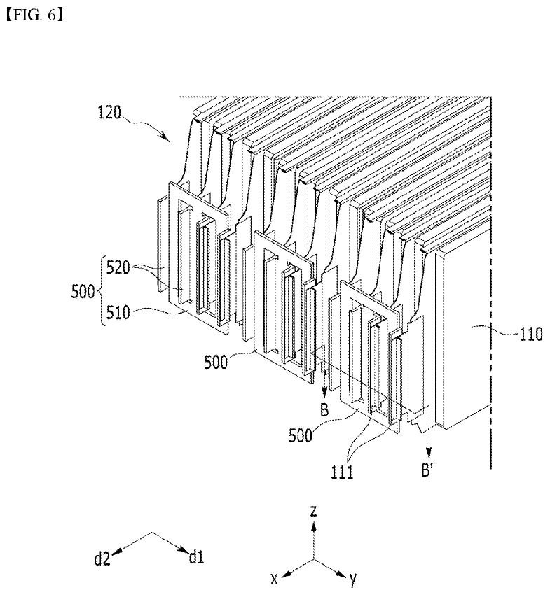

FIG. 4 is an exploded perspective view showing a battery module according to an embodiment of the present disclosure. FIG. 5 is a plan view showing one of the battery cells included in the battery module of FIG. 4. FIG. 6 is a partial perspective view showing the battery cell stack and busbar included in the battery module of FIG. 4.

Referring to FIGS. 4 to 6, the battery module 100 according to an embodiment of the present disclosure includes a battery cell stack 120 in which battery cells 110 are stacked along a first direction d1, and at least one busbar 500 located on one side or both sides of the battery cell stack 120.

The busbar 500 is a medium for electrical connection between the electrode leads 111 of the battery cells 110, and preferably includes a metal material. Whether or not the busbar 500 is located on one side or both sides of the battery cell stack 120 is determined depending on whether the electrode lead 111 of the battery cell 110 protrudes in only one direction or whether it protrudes in both directions. Below, the battery cell 110 according to the present embodiment will be first specifically described.

The battery cell 110 may be a pouch-type battery cell, and may have a rectangular sheet shape. The battery cell 110 can be formed by housing an electrode assembly in a pouch case of a laminate sheet including a resin layer and a metal layer, and then adhering the outer peripheral part of the pouch case. Specifically, the battery cell 110 may have a structure in which two electrode leads 111 face each other and protrude from one end 114a and the other end 114b of the cell main body 113, respectively. As another embodiment, a structure in which the electrode leads 111 of the battery cells 110 all protrude in one direction is also available. One of the electrode leads 111 is a positive electrode lead, and the other is a negative electrode lead.

The battery cell 110 can be produced by joining both ends 114a and 114b of a pouch case 114 and one side part 114c connecting them in a state in which an electrode assembly (not shown) is housed in a pouch case 114. In other words, the battery cell 110 according to the present embodiment has a total of three sealing portions, the sealing portions have a structure that is sealed by a method such as fusion, and the remaining other one side part may be composed of a folding part 115. That is, the battery cell 110 according to the present embodiment may be a pouch-type battery cell configured to house an electrode assembly inside the pouch case 114 and seal the outer peripheral part of the pouch case 114.

Such battery cells 110 are stacked along the first direction d1 to form the battery cell stack 120. Specifically, in the battery cell stack 120, the battery cells 110 may be stacked along the first direction d1 in an upright state so that one-side surfaces of the battery cells 110 face each other.

The electrode leads 111 protrude from the battery cell along the second direction d2 perpendicular to the first direction d1. Thereby, the busbar 500 may be located on one side in the second direction d2 with respect to the battery cell stack 120.

In the present disclosure, the first direction d1 is shown to be the y-axis direction, and the second direction d2 is shown to be the x-axis direction.

If the electrode leads 111 of the battery cell 110 is configured to protrude in both directions from the battery cell 110, other electrode leads 111 can protrude in a direction opposite to the second direction d2, that is, in the-x axis direction. Thereby, other busbars 500 may also be located on one side of the battery cell stack 120 in a direction opposite to the second direction d2.

Below, the configuration of the busbar and the junction between the busbar and the electrode lead according to the present embodiment will be described in detail.

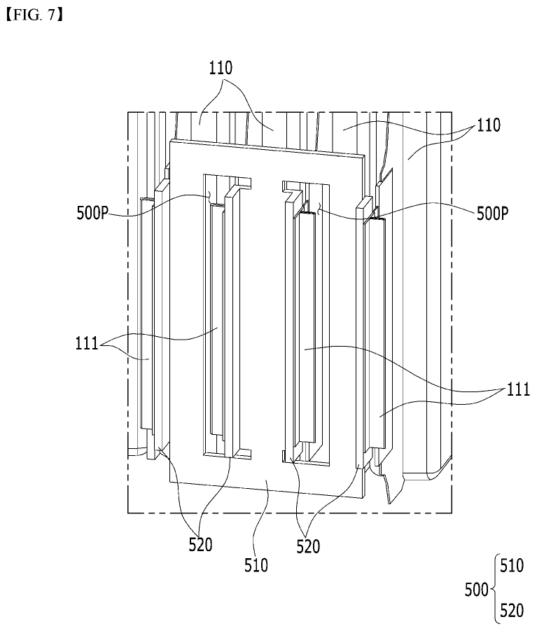

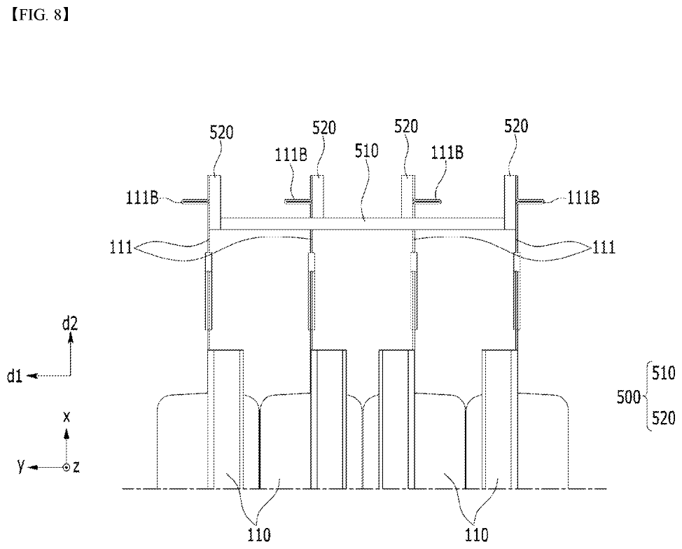

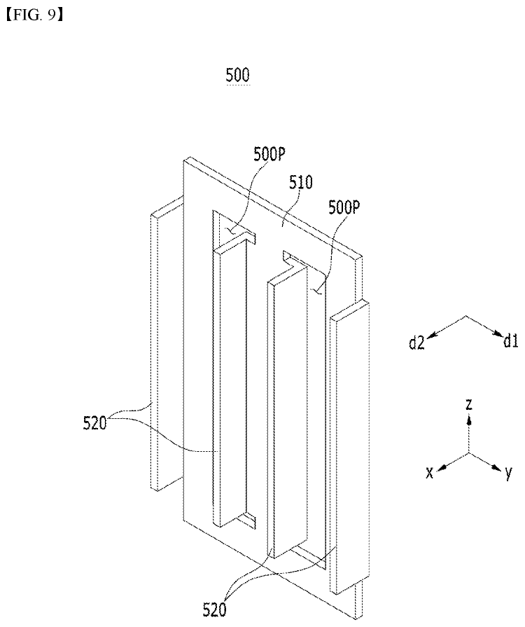

FIG. 7 is a partial view which enlarges and shows the joining portion between the electrode leads of the battery cells and the busbar in FIG. 6. FIG. 8 is a cross-sectional view showing a cross-section taken along the cutting line B-B′ of FIG. 6. FIG. 9 is a perspective view showing a busbar according to an embodiment of the present disclosure.

Referring to FIGS. 6 to 9 together, the busbar 500 according to the present embodiment includes a first portion 510, and a second part 520 that extends from the first portion 510 at a constant angle with one surface of the first portion 510, wherein the electrode lead 111 of the battery cell 110 is joined to the second portion 520. As previously described, the busbar 500 is a medium for electrical connection between the battery cells 110, which is a member that is joined to the electrode lead 111 of the battery cell 110.

As one example, the second portion 520 may extend at an angle of 45 degrees or more and 135 degrees or less with one surface of the first portion 510. More specifically, the second portion 520 may be extended so that one surface of the second portion 520 is perpendicular to one surface of the first portion 510. In particular, one surface of the first portion 510 may be parallel to the first direction d1, and one surface of the second portion 520 may be parallel to the second direction d2. In other words, one surface of the first portion 510 may be parallel to the direction in which the battery cells 110 are stacked, and the second portion 520 may be parallel to the direction in which the electrode lead 111 protrudes from the battery cell 110.

In the present embodiment, the busbar 500 is not composed of only the first portion 510, but further includes a second portion 520 that makes a constant angle with the first portion 510, and the electrode lead 111 is joined to this second portion 520.

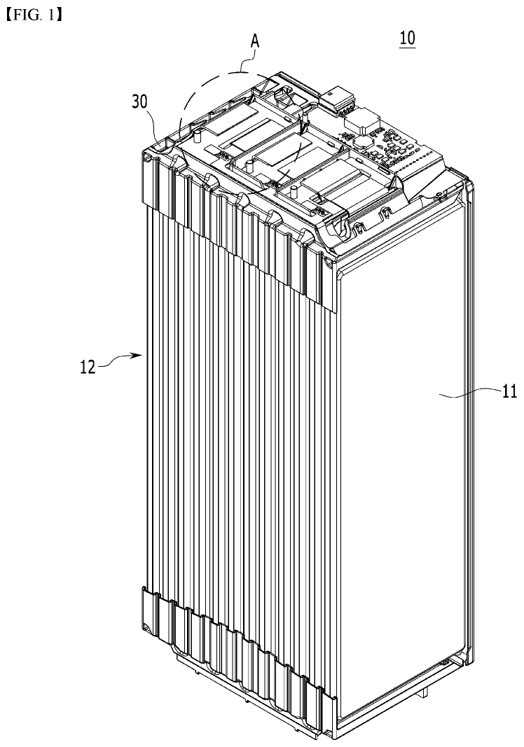

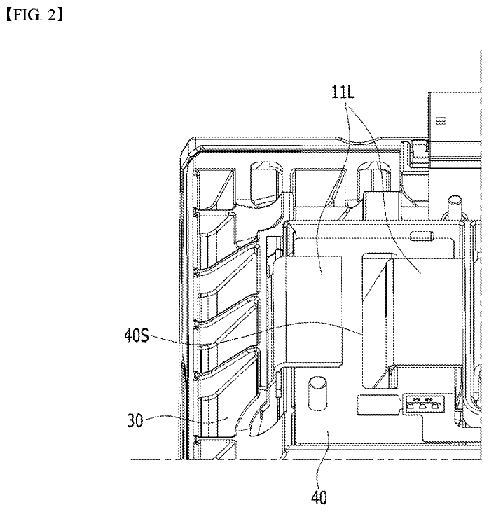

If the busbar consists of only the first portion, it has a structure similar to the conventional busbar 40 described in FIGS. 1 to 3. When the electrode lead 11L is joined to the busbar 40 as mentioned above, the electrode lead 11L is bent to form the bent portion 11LB in order to bring the electrode lead 11L into close contact with the surface of the busbar 40. Thereby, a process of cutting the electrode lead 11L and a process of bending the electrode lead 11L were essentially required, and breakage was generated in the electrode lead 11L due to the tensile force TF generated in the process of bending the electrode lead 11L.

In the case of the busbar 500 according to the present embodiment, a second portion 520 is further provided, and the electrode lead 111 is joined to this second portion 520. Therefore, in the process of joining the electrode lead 111 to the busbar 500, there is no need to bend the electrode lead 111. Since the tensile force due to bending does not act on the electrode lead 111, it is possible to prevent breakage of the electrode tab or breakage of the connecting portion between the electrode tab and the electrode lead.

Further, since the process of bending the electrode lead is not necessary and respective battery cells 110 can be located regularly from the joining portion between the electrode lead 111 and the busbar 500, the process of cutting the electrode lead 111 is also not necessary. In other words, since partial processes can be eliminated, product production costs can be reduced, and productivity can be improved.

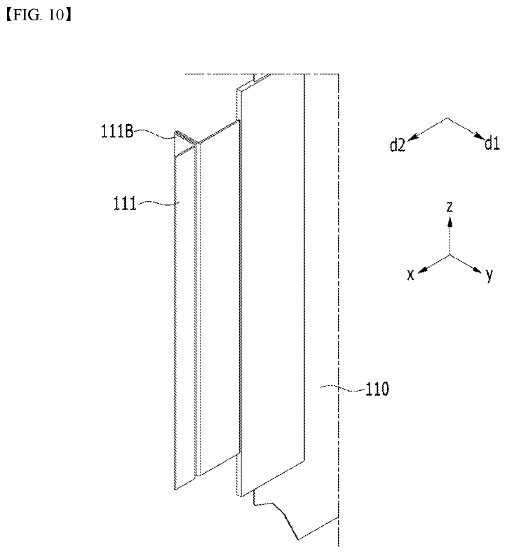

The joining method between the electrode lead 111 and the second portion 520 is not particularly limited as long as electrical connection between the electrode lead 111 and the second portion 520 is available. As one example, the electrode lead 111 may be welded and joined to the second portion 520. That is, the electrode lead 111 may be formed with a joining portion due to welding junction. The welding junction and the joining portion will be described again below along with FIGS. 10 to 13.

The busbar 500 according to the present embodiment may be formed with an open portion 500P, and at least one of the electrode leads 111 may be bonded to the second portion 520 while passing through the open portion 500P. In particular, the first portion 510 of the busbar 500 may be formed with an open portion 500P. Multiple second portions 520 may be provided on one busbar 500, and an open portion 500P may be provided in order to join the electrode lead 111 to the second portion 520 located on the central side rather than the outermost side. Further, the other electrode leads 111 may be joined to the second portion 520 without passing through the open portion 500P, as illustrated. In particular, some of the electrode leads 111 may be joined to the second portion 520 located on the outermost side without passing through the open portion 500P.

As described above, one busbar 500 is provided with a plurality of second portions 520, so that respective battery cells 110 may be located regularly from the joining portion between the electrode lead 111 and the busbar 500. Thereby, unlike a conventional technique, the process of cutting the electrode lead is not necessary. The open portion 500P is a portion provided for convenience of junction between some of the electrode leads 111 and the second portion 520, when multiple second portions 520 are formed on one busbar 500.

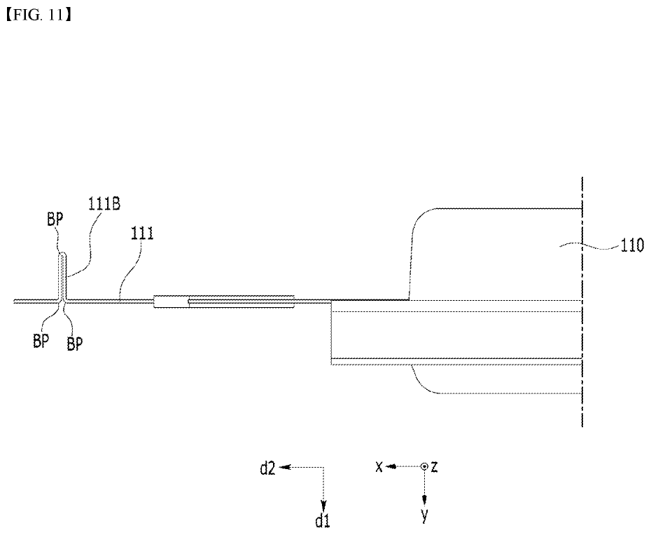

Next, the electrode lead according to this embodiment and the bead portion formed thereon will be described in detail with reference to FIGS. 10 and 11.

FIGS. 10 and 11 are figures showing electrode leads of a battery cell according to an embodiment of the present disclosure, respectively. Specifically, FIG. 10 is a partial perspective view of an electrode lead according to the present embodiment. FIG. 11 is a plan view of the electrode lead according to the present embodiment as viewed along the -z axis direction on the xy plane.

Referring to FIGS. 10 and 11 together with FIGS. 7 and 8, since the electrode lead 111 according to this embodiment is joined to the second portion 520 as described above, there is no need to bend the lead perpendicular to the direction in which it protrudes from the battery cell 110.

The electrode lead 111 according to this embodiment may be formed with a bead portion 111B protruding in a direction different from the second direction d2. That is, although the electrode lead 111 protrudes from the battery cell 110 along the second direction d2, it is not simply formed in a plate shape, but a bead portion 111B that protrudes in a direction different from the second direction d2 can be formed in a middle portion of the electrode lead 111. More specifically, the bead portion 111B may protrude from the middle portion of the electrode lead 111 in a direction parallel to the first direction d1.

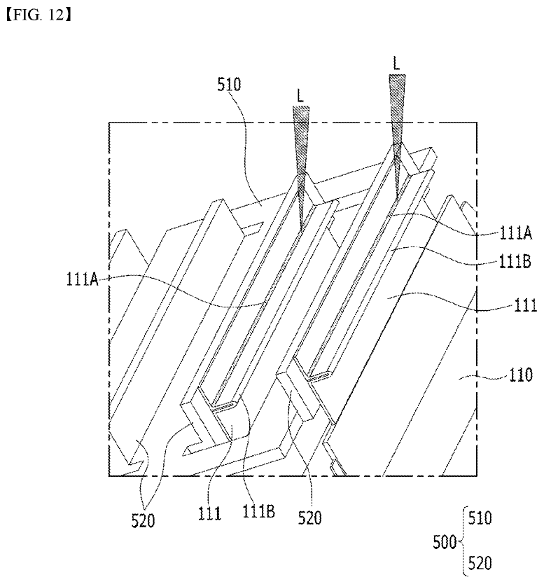

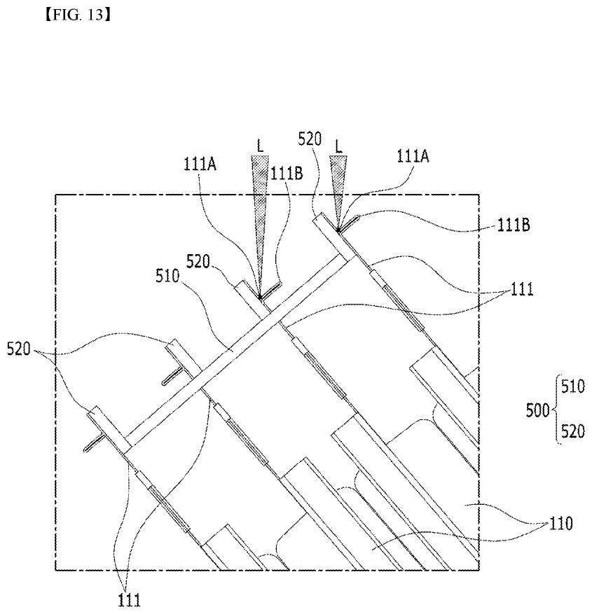

The welding junction of the electrode lead 111 and the function of the bead portion 111B according to the present embodiment will be described with reference to FIGS. 12 and 13.

FIGS. 12 and 13 are diagrams showing the process of joining an electrode lead and a busbar according to an embodiment of the present disclosure, respectively.

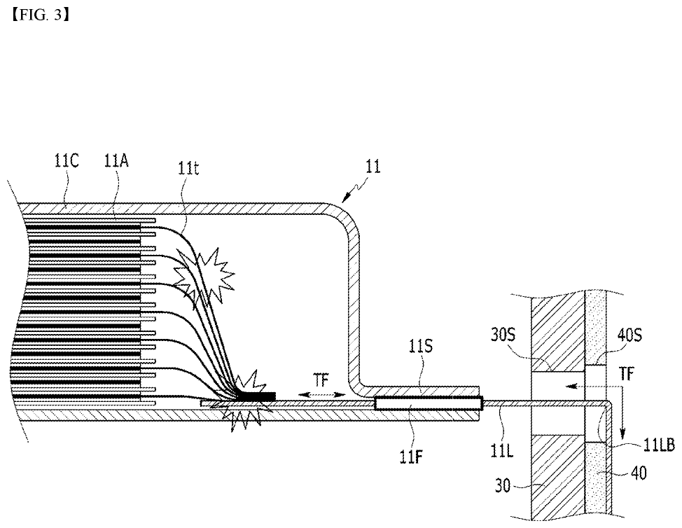

Referring to FIGS. 12 and 13 together with FIGS. 8, 10, and 11, the electrode lead 111 may be welded and joined to the second portion 520 as previously described. The second portion 520 is provided on the busbar 500, and the electrode lead 111 does not need to be bent, but the welding process may be difficult compared to the conventional electrode lead 11L in a bent form. As shown in FIG. 3, in the conventional case, since the electrode lead 11L is bent, the portion where the electrode lead 11L and the busbar 40 are in close contact can be seen from the front, and welding is performed by irradiating the relevant portion with a laser, etc., so that the welding process is relatively simple. On the other hand, since the electrode lead 111 according to the present embodiment does not have a portion bent at a right angle, the portion where the electrode lead 111 and the second portion 520 are in close contact is not the surface seen from the front, and it may be difficult to irradiate the laser due to an angle.

In order to improve weldability and achieve a stable welding junction between the electrode lead 111 and the second portion 520, according to this embodiment, the above-mentioned bead portion 111B was formed on the electrode lead 111.

As shown in FIGS. 12 and 13, the joining portion 111A, which is a joining portion of the electrode lead 111 and the second portion 520, may be provided at a portion where the bead portion 111B is connected to the electrode lead 111. Here, the portion where the bead portion 111B is connected to the electrode lead 111 refers to the starting portion where the bead portion 111B begins to protrude from the electrode lead 111. That is, the portion where the bead portion 111B is connected to the electrode lead 111 may be joined to the second portion 520 to form a joining portion 111A.

More specifically, a portion where the bead portion 111B is connected to the electrode lead 111 to form a joining portion 111A can be irradiated with the laser L to form the joining portion 111A. The joining portion 111A can be formed by irradiating with the laser L while making an angle of about 45 degrees with one surface of the second portion 520, through which the electrode lead 111 and the busbar 500 can be electrically connected. As previously explained, the portion where the electrode lead 111 and the second portion 520 are in close contact is not a surface that is seen from the front, but since the bead portion 111B is provided and the laser L inclined at a certain angle is irradiated to the portion where the bead portion 111B is connected to the electrode lead 111, a stable welding process can be achieved. That is, the bead portion 111B according to the present embodiment can be provided so as to improve the welding processability so that the electrode lead 111 protruding along the second direction d2 can be stably welded and joined to the second portion 520.

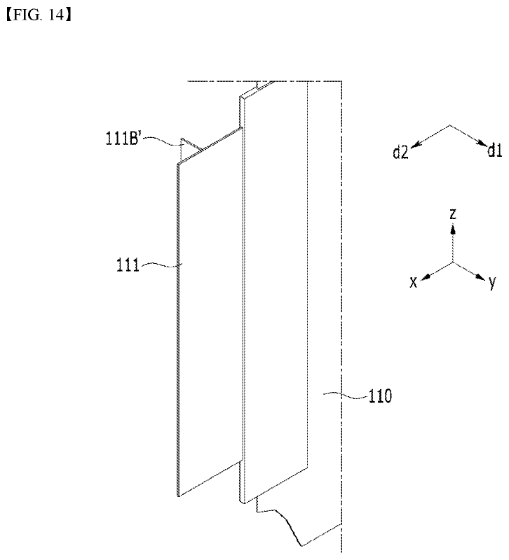

FIG. 14 is a diagram showing an electrode lead of a battery cell according to another embodiment of the present disclosure.

Referring to FIG. 14, the electrode lead 111 according to another embodiment of the present disclosure may have a bead portion 111B′. The bead portion 111B′ may protrude from the middle portion of the electrode lead 111 in a direction different from the second direction d2, for example, in a direction parallel to the first direction d1. This is similar to the bead portion 111B described above. The bead portion 111B′ according to the present embodiment may be formed by attaching a plate-shaped member to the middle portion of the electrode lead 111.

On the other hand, referring again to FIGS. 10 and 11, the bead portion 111B according to an embodiment of the present disclosure may be a portion formed by bending the electrode lead 111 at least three times. FIG. 11 shows a case in which three bending portions BP are formed in the electrode lead 111 to finally form a bead portion 111B. Unlike the bead portion 111B′ to which a plate-shaped member is attached, the bead portion 111B according to the present embodiment can be formed by simply bending the electrode lead 111 multiple times, and thus, it has the advantage that the production method is simple. That is, the bead portions 111B and 111B′ in the present disclosure is not particularly limited in their configuration as long as they protrude from the electrode lead 111 in a direction different from the second direction d2, but when considering the convenience of the production method, the bead portion 111B formed by bending the electrode lead 111 at least three times may be preferable.

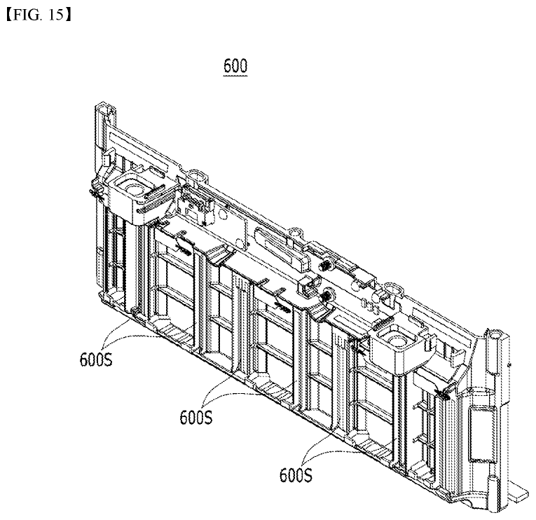

FIG. 15 is a perspective view showing a busbar frame according to an embodiment of the present disclosure.

Referring to FIGS. 6 and 15 together, the battery module according to the present embodiment may further include a busbar frame 600. In FIG. 6, only the busbar 500 is shown for convenience of explanation, but the busbar frame 600 may be located between the battery cell stack 120 and the busbar 500. The busbar 500 can be mounted on such a busbar frame 600.

Specifically, the busbars 500 are mounted on one surface of the busbar frame 600, and the battery cell stack 120 may be located on the other surface of the busbar frame 600. The electrode leads 111 of the battery cell 110 passes through a slit 600S formed in the busbar frame 600, and can be joined to the busbar 500. The junction between the electrode lead 111 and the busbar 500 has been described previously, and therefore, a description thereof will be omitted.

The busbar frame 600 may include an electrically insulating material. As one example, the busbar frame 600 may include a plastic material that is electrically insulating. The busbar frame 600 is a member disposed to prevent a short circuit from occurring when a portion of the battery cells 110 other than the electrode lead 111 is joined to the busbar 500.

Although not specifically shown, the busbar frame 600 may be mounted with a terminal busbar that functions as an external input/output terminal and a sensing assembly that transmits temperature and voltage information of the battery cell.

Referring again to FIG. 4, the battery module 100 according to the present embodiment may further include a module frame 200 in which the battery cell stack 120 is housed. The module frame 200 is a member that houses the battery cell stack 120 therein, and may include two side surface portions 210 and 220, an upper surface portion 230, and a lower surface portion 240. Further, the module frame 200 may have a configuration in which both sides corresponding to the second direction and the opposite direction are open. The battery cell stack 120 can be housed through either of the two open sides. The module frame 200 may include a metal material having a predetermined strength in order to protect internal electrical components.

The module frame 200 shown in FIG. 4 may be a mono frame in which two side surface portions 210 and 220, an upper surface portion 230, and a lower surface portion 240 are integrated. That is, it may be produced by extrusion molding, and can have a configuration in which the two side surface portions 210 and 220, the upper surface portion 230, and the lower surface portion 240 are integrated. Although not specifically shown, in another embodiment of the present disclosure, a module frame in which the U-shaped frame and upper plate are welded together is also available. Looking at the stacking direction of the module frame 200 and the battery cells 110, the battery cells 110 may be stacked from one side surface portion 210 to the other side surface portion 220 so that one surface of the battery cells 110 is parallel to one surface of the side surface portions 210 and 220 of the module frame 200.

On the other hand, the battery module 100 according to the present embodiment may further comprise end plates 300 located on both open sides of the module frame 200. The end plates 300 may be located so as to cover the battery cell stack 120 on both open sides of the module frame 200. The edges of respective end plates 300 may be joined to the corresponding edges of the module frame 200 by a welding method. The end plates 300 may include a metal material having a predetermined strength, and may protect the battery cell stack 120 and other electrical components from external impact. The busbar 500 and busbar frame 600 described above may be located between the end plate 300 and the battery cell stack 120.

The battery module 100 may further comprise a thermal resin layer 400 located between the battery cell stack 120 and the lower surface portion 240 of the module frame 200. One side of the battery cells 110 may be adhered to the thermal resin layer 400. Specifically, the thermal resin layer 400 may be formed by injecting or applying a thermal resin and then curing it. The thermal resin may include a thermally conductive adhesive material, and specifically may include at least one of a silicone material, a urethane material, or an acrylic material. The thermal resin can be in a liquid phase during application, but can be cured after application to be adhered to one side of the battery cell 110. Thereby, the thermal resin layer 400 may serve to fix the battery cells 110. In addition, the thermal resin layer 400 has excellent heat conduction properties, and can quickly transfer heat generated in the battery cell 110 to the lower side of the battery module.

The terms representing directions such as the front side, the rear side, the left side, the right side, the upper side, and the lower side have been used in the present embodiment, but the terms used are provided simply for convenience of description and may become different according to the position of an object, the position of an observer, or the like.

The one or more battery modules according to embodiments of the present disclosure described above can be mounted together with various control and protection systems such as a BMS (battery management system), a BDU (battery disconnect unit), and a cooling system to form a battery pack.

The battery module or the battery pack can be applied to various devices. Specifically, it can be applied to vehicles such as electric bikes, electric vehicles, and a hybrid electric vehicles, or an ESS (Energy Storage Systems), and can be applied to various devices capable of using a secondary battery, without being limited thereto.

The invention has been described in detail with reference to preferred embodiments thereof. However, it will be appreciated by those skilled in the art that the scope of the present disclosure is not limited thereto, and various modifications and improvements can be made in these embodiments without departing from the principles and sprit of the invention, the scope of which is defined in the appended claims and their equivalents.

### DESCRIPTION OF REFERENCE NUMERALS

100: battery module

110: battery cell

111: electrode lead

111A: joining portion

111B: bead portion

120: battery cell stack

200: module frame

300: end plate

400: thermal resin layer

500: busbar

510: first portion

520: second portion

600: busbar frame

1. A battery module comprising:
a battery cell stack in which battery cells are stacked along a first direction; and
at least one busbar located on one side or both sides of the battery cell stack,
wherein an electrode lead protrudes from one of the battery cells along a second direction perpendicular to the first direction,
wherein the busbar comprises a first portion, and a second portion that extends from the first portion at a certain angle with respect to one surface of the first portion, and
wherein the electrode lead is joined to the second portion.

2. The battery module as claimed in claim 1, wherein:
the battery cell is a pouch-type battery cell, and
in the battery cell stack, the battery cells are stacked in an upright state so that side surfaces of the battery cells face each other.

3. The battery module as claimed in claim 1, wherein:
the second portion extends so that one surface of the second portion is perpendicular to the one surface of the first portion.

4. The battery module as claimed in claim 1, wherein:
the one surface of the first portion is parallel to the first direction, and one surface of the second portion is parallel to the second direction.

5. The battery module as claimed in claim 1, wherein:
the electrode lead is welded and joined to the second portion.

6. The battery module as claimed in claim 1, wherein:
the busbar is formed with an open portion, and
the electrode leads is joined to the second portion while passing through the open portion.

7. The battery module as claimed in claim 1,
further comprising a busbar frame located between the battery cell stack and the busbar, and the busbar is mounted on the busbar frame,
wherein the busbar frame is formed with a slit, and
wherein the electrode lead passes through the slit and is joined-to the second portion of the busbar.

8. The battery module as claimed in claim 1, wherein:
the electrode lead is formed with a bead portion protruding in a direction different from the second direction.

9. The battery module as claimed in claim 8, wherein:
the bead portion protrudes from a middle portion of the electrode lead in a direction parallel to the first direction.

10. The battery module as claimed in claim 8, wherein:
the bead portion is a portion formed by bending the electrode lead at least three times.

11. The battery module as claimed in claim 8, wherein:
a joining portion, which is a portion where the electrode lead and the second portion are joined, is provided at a portion where the bead portion is connected to the electrode lead.

12. The battery module as claimed in claim 11, wherein:
the portion where the bead portion is connected to the electrode lead is irradiated with a laser to form the joining portion.

13. The battery module as claimed in claim 1,
further comprising a module frame in which the battery cell stack is housed.

14. A battery pack comprising the battery module as claimed in claim 1.
